(19) United States
(12) Patent Application Publication
(10) Pub. No.: US 2004/0222978 A1
(43) Pub. Date: Nov. 11, 2004

(54) Control and communications panel for a computer system

(76) Inventors: Eric Gould Bear, Bellevue, WA (US); Chad Magendanz, Issaquah, WA (US); Aditha May Adams, Seattle, WA (US); Carl Ledbetter, Mercer Island, WA (US); Steve Kaneko, Medina, WA (US)

Correspondence Address: Law Offices of Albert S. Michalik, PLLC, Suite 193, 704-228th Avenue NE, Sammamish, WA, 98074, US

(21) Appl. No.: 10/429,933

(22) Filed: May 5, 2003

(51) Int. Cl. G09G 5/00; G09G 3/00; G09G 3/36; G06F 13/14; G09G 1/06

(52) U.S. Cl. 345/184; 345/30; 345/90; 345/520; 345/10; 345/11

(57) ABSTRACT

A control and communications panel that provides users with an easy way to perform computing tasks. The panel may be located in any convenient location, such as in a location that the user can easily see and reach. The control and communications panel provides various controls such as buttons corresponding to computing tasks, including program-related and communications-related tasks. When operated, each control notifies the operating system (or other program) of a state change, and control handling logic processes the state data to take an appropriate action. Indicators such as LEDs related to the controls convey state information to users. USB ports and/or media drives or storage media may be included in the control and communications panel.

### CROSS-REFERENCE TO RELATED APPLICATIONS

The present invention is related to the following copending United States Patent Applications filed concurrently herewith, assigned to the assignee of the present invention, and hereby incorporated by reference in their entireties:

“Method and System for Auxiliary Display of Information for a Computing Device,” Attorney Docket No. 3810;

“Real-Time Communications Architecture and Methods for use with a Personal Computer System,” Attorney Docket No. 3820;

“Record Button on a Computer System,” Attorney Docket No. 3830;

“Method and System for Auxiliary Processing Of Information for a Computing Device,” Attorney Docket No. 3840;

“System and Method for Activating a Computer System;” Attorney Docket No. 3850;

“Computer System with Do Not Disturb System and Method,” Attorney Docket No. 3860;

“Computer Camera System and Method for Reducing Parallax,” Attorney Docket No. 3870;

“Notification Lights, Locations and Rules for a Computer System,” Attorney Docket No. 3900.

### FIELD OF THE INVENTION

The invention relates generally to computer systems and communications.

### BACKGROUND OF THE INVENTION

In contemporary computing on desktop personal computers and the like wherein the housing is separate from the keyboard, monitor and pointing device, the general philosophy has been to provide access to the computer system's functionality in the easiest way from a physical standpoint, in part to minimize the amount of interaction with the main housing. Thus, except for relatively infrequent actions such as pressing a power button, inserting or removing media, and attaching a connector, computing tasks are accomplished through software control via the keyboard and mouse, and more recently, through voice recognition, all of which are physically easy for the user. This also saves money for manufacturers, since tasks are performed by components that are already there.

However, while physically easy, software interaction is not necessarily the simplest or most efficient way for the user to accomplish a computing task, which is really what most users want. For example, to perform a task via software interaction, the user may have to find and launch an appropriate program, find and locate a command on a menu and possibly a submenu, click on or otherwise activate the command, and then possibly interact with a dialog corresponding to the command.

Some computer manufacturers have realized that software interaction is not always the best solution for most uses, and for example have put controls near a media player (e.g., DVD-ROM) drive so that the user can simply insert prerecorded media and play the media as if the computer system was a conventional appliance. While more expensive to produce a machine with such controls, the added convenience appeals to some users such as those that only have limited knowledge of application programs.

At the same time, physical access to the machine may be inconvenient or undesirable for many users. For example, many users would prefer to position a machine somewhat remotely and/or in an isolated area, so as to not have to hear the fan of a computer system, have a large number of wires visible, and so forth. On the other hand, some access is necessary such as to insert and remove media. Thus, there is a tradeoff between positioning a machine based on ease of access versus positioning a machine in an out of the way location, e.g., to reduce noise and hide wiring.

What is really desired is not necessarily access to the personal computer housing, but rather access to personal computer functionality in an efficient manner that is easy to use, both physically and mentally. Users want to physically interact with the computer system's functionality as easily as they currently can with a monitor, keyboard and pointing device, yet without having to learn to operate different software programs to perform each task. At the same time, some users generally do not want to think about the computer system itself, and/or may even want to locate the computer housing in an isolated area, such as far enough away to be essentially silent and hide any unsightly wires that may be present.

### SUMMARY OF THE INVENTION

Briefly, the present invention provides a control and communications panel that provides users with easy access to the computer system's functionality for many frequently-performed computing tasks. The control and communications panel may be located in any convenient location from the perspective of the user, such as in a location that the user can easily see and reach. The location may be on the main housing, but may instead be detached from the housing and include any mechanisms that were traditionally on the housing so as to allow the housing to be positioned away from the computer user.

In general, the control and communications panel provides various controls such as buttons corresponding to computing tasks, including program-related and communications-related tasks. This provides easy physical access to many common or important functions, and if the function requires interaction with software, (e.g., to scroll through a list of email messages), makes it easier to use the software program by automatically performing the steps needed to get to a desired function or feature within the software. Example functional controls include communication-related (e.g., telephone-related, voice mail and email) controls, power, security and system-related controls, transport controls, and camera, microphone and volume controls.

Various alternative locations for easy access to the control and communications panel are provided. For example, the control and communications panel may be positioned beneath the monitor, positioned between the keyboard and monitor, or adjacent the keyboard or monitor. The control and communications panel may be a standalone unit that moves, like a wired or wireless remote control. The control and communications panel may be integrated into a keyboard or monitor, attached to a keyboard or monitor, or split between a keyboard and monitor in some logical arrangement as a virtual panel.

In general, when operated, each control notifies the operating system or application program, (hereinafter generically referred to as a control handling program or the like) of what is occurring, that is, the control provides some state data to the control handling program. Note that at least the power button may be somewhat of an exception, because the control handling program may not be running when the power button is pressed, and thus, for example, the power button will trigger start up or wake up logic when appropriate. The state data may correspond to a simple (single-throw) state change, or may be more complex such as a set of state changes (e.g., like a double-click or other actuation method) or possibly a value (e.g., a rotating knob or slider level).

Control handling logic then processes the received control state data to take an appropriate action or set of actions. For example, a user pushing a button may result in the operating system launching an application program (if not already launched), and moving to a particular feature within that application program. For example, pressing an email button may be the same as opening the email program and displaying the most recent unread message in the inbox (which may not necessarily be the starting folder if launched via software), with other messages (however sorted) listed below that message.

Indicators such as LEDs and/or an auxiliary display may be provided, such as to output status information, as well as output other useful information not necessarily provided on the main display. Each of the indicators may be related to one of the controls, and thus each indicator may be incorporated into or positioned proximate its corresponding control. Other indicators unrelated to any controls are possible. Indicator/display logic controls the indicators and the display, which may be the auxiliary display or the main display. Colors and illumination patterns (frequencies, duty cycles, number of pulses, and so forth) may be varied to convey different information to users.

In various implementations, USB ports and/or media drives or other storage media may be included in the control and communications panel, thus further reducing the need for access to the main computer housing.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a general representation of a computer system arranged with a control and communications panel coupled to the system in accordance with an aspect of the present invention;

FIG. 3 is a general representation of a computer system arranged with a control and communications panel on a main computer housing in accordance with an aspect of the present invention;

FIG. 4 is a general representation of a computer system arranged with a control and communications panel positioned below a display monitor in accordance with an aspect of the present invention;

FIG. 5 is a general representation of a computer system arranged with a control and communications panel positioned above a keyboard in accordance with an aspect of the present invention;

FIG. 6 is a general representation showing controls and indicators on an example alternative control and communications panel in accordance with an aspect of the present invention; and

FIG. 7 is a block diagram representing various components for implementing a control and communications panel in accordance with an aspect of the present invention.

### DETAILED DESCRIPTION

Exemplary Operating Environment

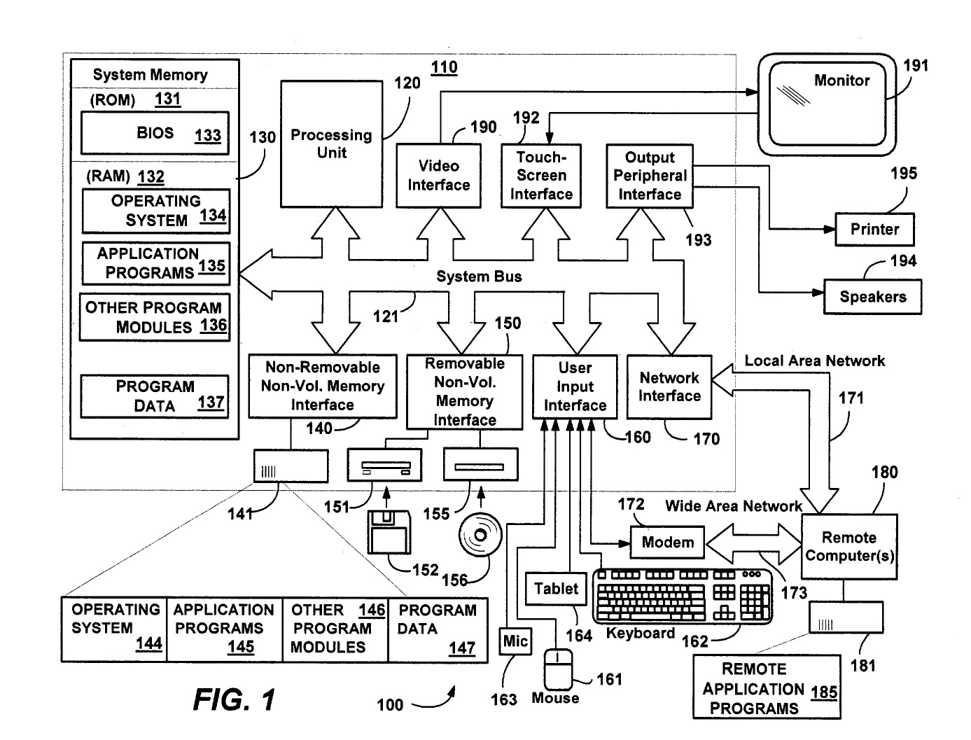

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Control and Communications Panel

The present invention is generally directed towards operating a computer system via a control and communications panel that appropriately handles user (or automated process) input including communications-related input. As such, the computer may be generally arranged as a central communications point for multiple communications-related mechanisms and programs. As will be understood, the various communication channels, controls, indicators and scenarios described herein are only examples, and there are many others to which the present invention will apply.

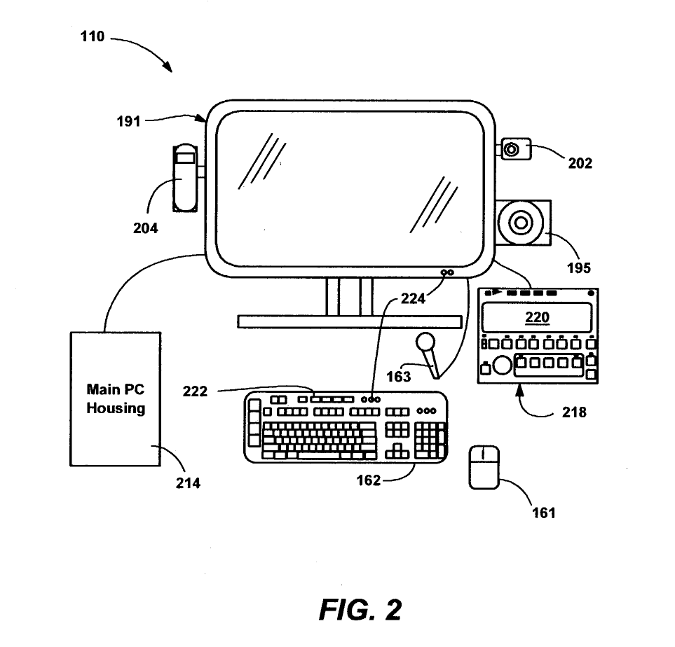

Turning to FIG. 2 of the drawings, there is shown a computer system, such as the computer system 110 of FIG. 1, in which various communications-related devices and other input output devices are integrated. For example, the computer system 110 includes a monitor 191 having an attached camera 202, an attached telephone (e.g., handset) 204, and an attached speaker 206, which along with a microphone 163, may function as a speakerphone. Other devices not separately represented in FIG. 2 include mobile communications devices such as a cellular telephone or other mobile computing device capable of connecting in some way (e.g., by wired cradle or wireless technology) with the computer system. Although shown as individual devices in FIG. 2, it is understood that any or all of these devices, such as the speaker 195 and microphone 163, may be combined into a unitary assembly, or built into other devices, such as the monitor 191. In any event, each of these devices may be present and if so are connected directly or indirectly by a wired or wireless connection to interfaces at the main PC housing 214 (containing at least the motherboard, but also typically containing some non-volatile storage).

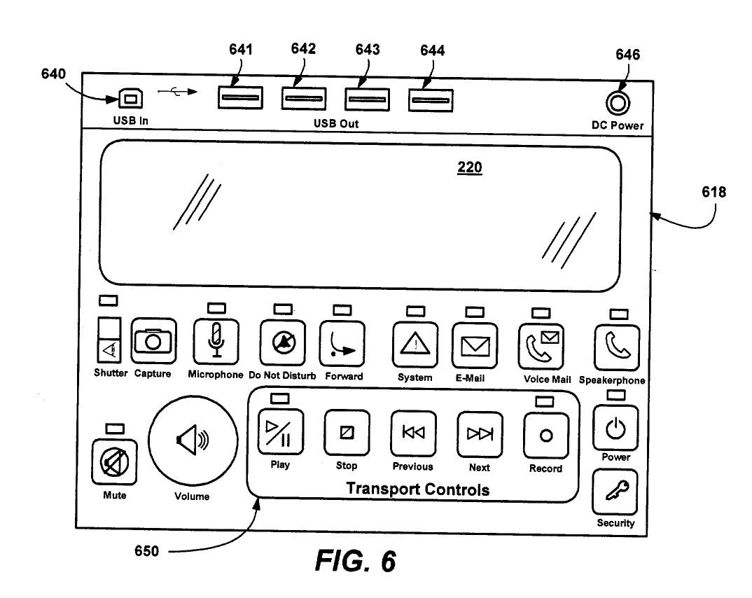

In accordance with an aspect of the present invention, there is provided a control panel, shown as the independently located control and communications panel 218, which provides access to the computer system functionality via various controls, and provides status information and the like via indicators. For example, as described below with reference to FIG. 6, these controls may include buttons corresponding to computing tasks, including program-related and communications-related tasks. This provides easy physical access to many common or important operations. Example functional controls include communication-related (e.g., telephone-related, voice mail and email) controls, power, security and system-related controls, transport controls, and camera, microphone and volume controls.

Also represented in FIG. 2 is an auxiliary display device 220. The auxiliary display 220 is typically small (relative to the main display screen 191), and may be incorporated into the control and communications panel's assembly. As is understood, the control panel need not have the auxiliary display combined with it, and there may not be an auxiliary display in a given implementation, or the auxiliary display may be located elsewhere. FIG. 2 further shows non-conventional buttons on the keyboard, and non-conventional LED indicators 224, to exemplify that some or all of the controls and indicator on the control and communications panel 218 may be repeated elsewhere in the general computing environment.

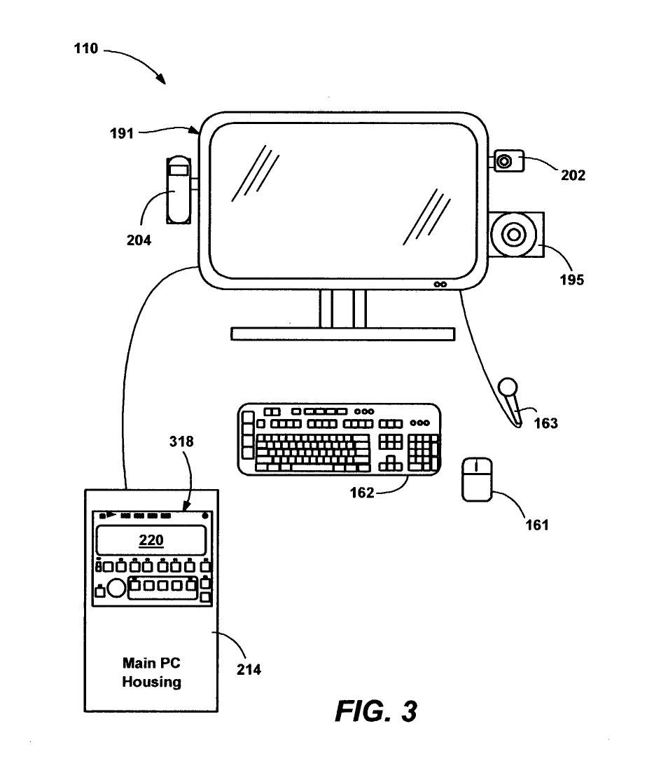

As generally represented in FIG. 3, the control and communications panel may be located essentially anywhere. Thus, for users that feel that it is convenient to have the control and communications panel 318 attached to the main PC housing, an implementation is provided. Note that the control and communications panel 218 may be detachable from the housing, e.g., the control and communications panel 218 in FIG. 2 may be the same as the control and communications panel 318 of FIG. 3, merely detached from the housing 214. Further, note that the control and communications panel may be part of the computer system originally, or a subsequent add on.

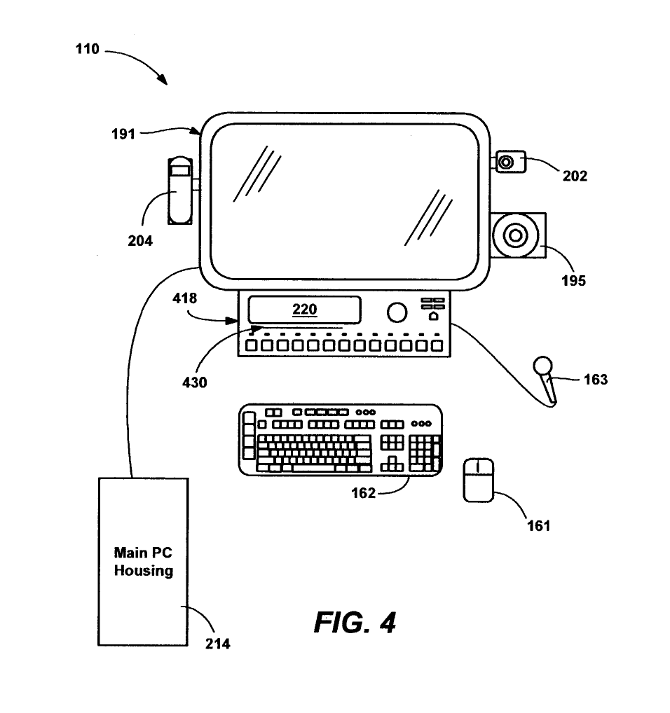

FIG. 4 shows another alternative representation in which a control and communications panel 418 is located in the space between the keyboard and monitor, such as beneath the monitor 191. The control and communications panel 418 may be part of or serve as the monitor's support stand, but need not be attached to the monitor 191 or even support it, as it may be slightly in front of the monitor. Note that FIG. 4 shows a microphone connected to the communications panel 418; it is understood that attaching other input or output devices such as headphones and/or headsets are equivalents

Also shown in FIG. 4 is a slot for inserting media, thus exemplifying that the control and communications panel 418 may include or be coupled to a media player 430. As can be readily appreciated, with such a media player, the control and communications panel 418 eliminates the need to have access to the main PC housing 214 in order to play back and/or record on removable media. Further, at least one storage media drive, slot or connector may be associated with the control and communications panel for things such as accessing data, transferring data, or installing applications. At least one wireless communications component (e.g. iRDA) may be associated with the control and communications panel for performing similar functions. A communications connector (e.g., IEEE 1394) associated with the control and communications panel also may be provided for things such as accessing or transferring data from peripherals or other computer systems.

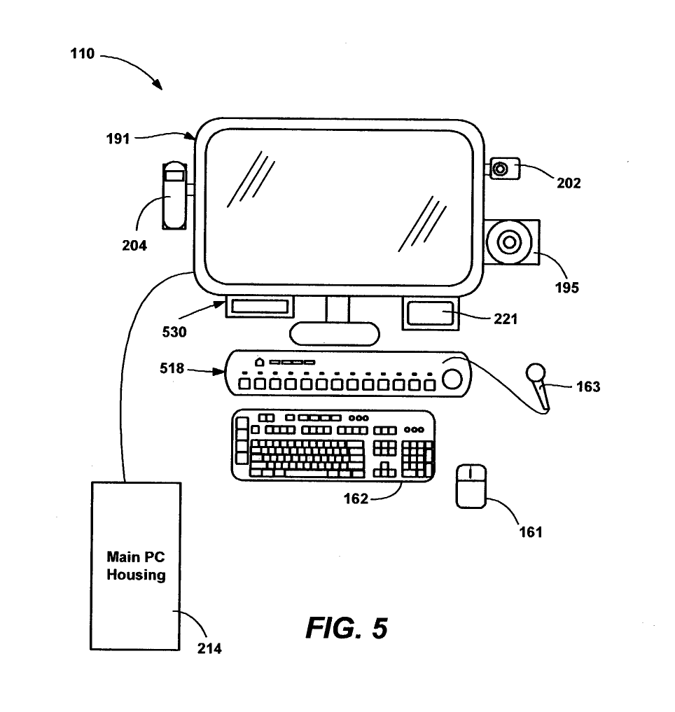

FIG. 5 is another alternative control and communications panel 518, exemplifying its positioning in a location between the keyboard and monitor, such as laying relatively flat like an auxiliary keyboard A media player 530 is shown attached to the monitor 191, as is an auxiliary display 221. It should be noted that the various locations and configurations of the control and communications panels in FIGS. 2-6 are only examples to show the many ways in which a control and communications panel may be provided, and it is understood that virtually any location is equivalent, as that virtually any shape, size and layout that is practical is possible.

FIG. 6 shows one example layout for arranging the controls and indicators on a control and communications panel 618. In addition to an auxiliary display 220 and controls and indicators (described below), FIG. 6 shows USB ports 640-644 and a DC power jack 646 on the control and communications panel 618. As can be appreciated, some or all of these items may be located on the sides, rear or top of the control and communications panel 618 instead of the front face. For example, the user may not want a DC power cable connecting in front.

As represented in FIG. 6, some of the functionality of a computer system may be accessed via simple interaction with the controls. For example, a shutter (slide) switch and capture button control a camera, while a microphone button toggles the on/off state of a microphone. Do not disturb, forward, voicemail and speakerphone buttons are provided to enhance communications associated with a computer system, as described in related patent applications entitled “Real-Time Communications Architecture and Methods for use with a Personal Computer System” and “Computer System with Do Not Disturb System and Method.”

A system button may be used to obtain information about the state of the system, e.g., its hardware and software health, and other non-urgent alerts, such as when a security-related patch is available for download and/or installation. This information is currently available through software, but for many users is difficult to access. Users without access rights to fix such problems may be given a read-only list along with instructions to contact an administrator (or the system may contact the administrator automatically), but possibly not until the system button is pressed a second time or actuated in a different manner, e.g., press and hold for one second to send a message to an administrator.

An email button may be used to automatically enter an email program. For example, pressing an email button when the indicator light indicates that a new message has been received may automatically generate the instructions necessary to open the email program (or switch it to foreground if already running) and display the most recent unread message in the inbox. If no new message has been received, pressing an email button may open the email program as would launching it from the operating system, which may not initially show the inbox, but instead a calendar, task list, or whatever the user decides to make as the initial folder at startup. Many other buttons are feasible, such as one that provides rapid and efficient access to instant messaging functionality.

Audio controls such as a mute button and volume control knob may also be provided, as may transport controls such as play stop, previous and next. A record button is a special type of transport control, as described in related patent application entitled “Record Button on a Computer System.”

Power and security are two other buttons that provide easy access to often needed functions. A security button may be used to toggle a user to a logged off state in which users are locked out until one logs back in. When locked out, pressing the security button may be used to obtain a login dialog.

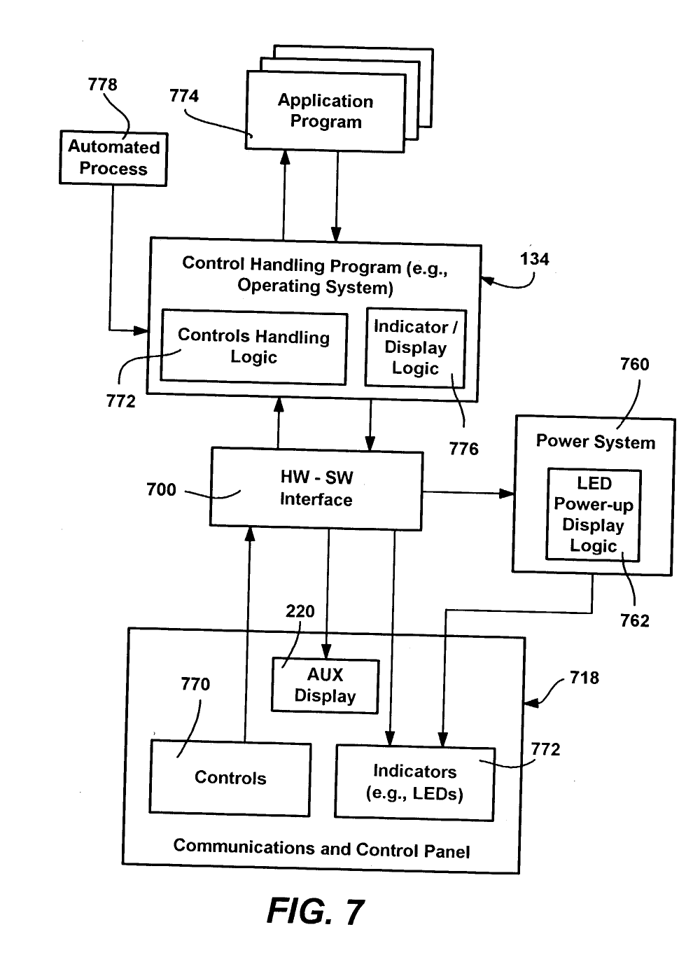

The power button controls the power state of the machine. As can be readily appreciated, the power button may be a special case button, because no software may be running to handle the power button actuation when the system is powered down. In general, in such a state, the power button is like a conventional power button on a contemporary PC, e.g., it triggers a start up or wakeup routine in the BIOS and similar firmware to move the system to an operational state. This is represented in FIG. 7 by the power system 760. Note however that the power system 760 may include logic 762 for controlling an indicator to do more than simply light an indicator when the power button is pressed, e.g., the LED may be driven with an illumination pattern and color to indicate the transitional powering-up state to the user.

FIG. 7 also shows how the controls 770 on the control and communications panel 718 may be used to perform computer and communications-related tasks. In general, state changes or the like in the controls are provided to the control handling program (e.g., the operating system 134, or an application program), along with data that identifies the control. Via controls handling logic 771, the control handling program then acts in the current context corresponding to the control. This may include generating one or more hardware or software events or commands, such as to launch an application program 774 when needed, lower the system volume, provide a log-in screen if in a locked mode or log a user out and enter a locked mode if operating, and so forth.

The control handling program also controls the indicators 772 as described above via indicator display logic 776 to convey information to the user. Note that the indicators need not be LEDs, but include any type of mechanism that outputs information that is capable of being sensed by a user, including visual, audible and tactile output. Each of the indicators may be related to one of the controls, and thus each indicator may be incorporated into or positioned proximate its corresponding control. Other indicators unrelated to any controls are possibly included in the control and communications panel 718. For LEDs, colors and illumination patterns (frequencies, duty cycles, number of pulses, and so forth) may be varied to convey different information to users regarding each control.

Although the control and communications panel 718 facilitates user control of the system, it should be noted that an automated process 778 may also perform like functions as if the user pressed a button, e.g., the computer system can enter a do not disturb mode by user actuation of a button or by an automated process such as a scheduled event generator that automatically puts the computer system into a do not disturb mode.

Further, although an operating system 134 (or some application program) is shown in FIG. 7 as handling the controls, it should be noted that the computer system need not be fully operational for (at least some of) the controls of the control and communications panel and/or the indicators to work in accordance with the present invention. Indeed, some of the controls may still work when the computer is powered down, at least to a default extent or to an extent configured by a user. For example, the speakerphone button along with the speakers and microphone may remain operational, whereby a user can use the speakerphone button to route the call to the speaker and microphone even when the system is otherwise powered down. In general, the user may want a telephone handset, speakerphone and caller-ID device to work as conventional appliances when the computer system is powered down, as well as the transport controls to allow media playback when the computer system is otherwise powered down. Other tasks that do not require a running operating system or application program similarly may remain operational when the operating system or application program is not available.

To handle the controls and communications in such a powered-down mode, the control handling logic may be loaded into executable non-volatile memory, operated with a secondary processor, and so forth, so that communication works as long as some power is available, even though the disk, main processor, main display, network card and/or other parts of the system are powered down.

As can be seen from the foregoing detailed description, there is provided a control and communications panel that facilitates access to a computer system's functionality. At the same time, the control and communications panel is not necessarily tied to the main computer housing, providing a more flexible computer system. The method and system thus provide significant advantages and benefits needed in contemporary computing and communications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer system, a subsystem comprising:
a control and communications panel, the control and communications panel including a plurality of controls that each correspond to a computing task; and
a control handling mechanism that receives state data from a selected control, and based on the state data performs an action related to the computing task to which the selected control corresponds.

2. The subsystem of claim 1 further comprising, an indicator that corresponds to the selected control, and an indicator control mechanism that controls the indicator to convey information corresponding to the state of the computing task to which the selected control corresponds.

3. The subsystem of claim 1 wherein the selected control comprises a button.

4. The subsystem of claim 1 wherein the selected control comprises a switch.

5. The subsystem of claim 1 wherein the selected control toggles between an on and off state when actuated.

6. The subsystem of claim 1 further comprising an auxiliary display associated with control and communications panel.

7. The subsystem of claim 1 wherein the selected control comprises a camera shutter control mechanism.

8. The subsystem of claim 1 wherein the selected control comprises a camera capture control mechanism.

9. The subsystem of claim 1 wherein the selected control comprises a microphone control mechanism.

10. The subsystem of claim 1 wherein the selected control comprises a do not disturb control mechanism.

11. The subsystem of claim 1 wherein the selected control comprises a communications control mechanism.

12. The subsystem of claim 11 wherein the communications control mechanism comprises a mechanism for forwarding a communication.

13. The subsystem of claim 11 wherein the communications control mechanism comprises a speakerphone control mechanism.

14. The subsystem of claim 1 wherein the selected control comprises an email control mechanism.

15. The subsystem of claim 1 wherein the selected control comprises a voice mail control mechanism.

16. The subsystem of claim 1 wherein the selected control comprises a power control mechanism.

17. The subsystem of claim 1 wherein the selected control comprises a security control mechanism.

18. The subsystem of claim 1 wherein the selected control comprises a volume control mechanism.

19. The subsystem of claim 18 wherein the volume control mechanism comprises a mute button.

20. The subsystem of claim 18 wherein the volume control mechanism comprises a volume level adjustment mechanism.

21. The subsystem of claim 1 wherein the selected control comprises a transport control mechanism.

22. The subsystem of claim 21 wherein the transport control mechanism comprises a play button.

23. The subsystem of claim 21 wherein the transport control mechanism comprises a stop button.

24. The subsystem of claim 21 wherein the transport control mechanism comprises a previous button.

25. The subsystem of claim 21 wherein the transport control mechanism comprises a next button.

26. The subsystem of claim 21 wherein the transport control mechanism comprises a record button.

27. The subsystem of claim 1 further comprising at least one connector associated with the control and communications panel for coupling another device to the computer system.

28. In a computer system, a method comprising:
providing, on a control panel, a plurality of controls and indicators that are each associated with to a computing task;
receiving state data corresponding to a selected control;
interpreting the state data to perform an action related to the computing task to which the selected control is associated; and
controlling an indicator to convey information about the state of the computing task to which the selected control is associated.

29. The method of claim 28 wherein receiving state data comprises receiving an indication that a button has been pressed.

30. The method of claim 28 wherein receiving state data comprises receiving an indication that a switch has been toggled.

31. The method of claim 28 wherein controlling an indicator comprises outputting data on a display.

32. The method of claim 28 wherein controlling an indicator comprises outputting data on an auxiliary display.

33. The method of claim 28 wherein controlling an indicator comprises illuminating an LED.

34. The method of claim 28 wherein controlling an indicator comprises using at least one member of a set containing visual, audible, and tactile representations.

35. The method of claim 28 wherein interpreting the state data to perform the action comprises controlling a camera shutter based on shutter state data received from the selected control.

36. The method of claim 28 wherein interpreting the state data to perform the action comprises operating a camera based on camera capture control data received from the selected control.

37. The method of claim 28 wherein interpreting the state data to perform the action comprises operating a microphone based on microphone control data received from the selected control.

38. The method of claim 28 wherein interpreting the state data to perform the action comprises setting a computer system do not disturb mode based on do not disturb control data received from the selected control.

39. The method of claim 28 wherein interpreting the state data to perform the action comprises forwarding a communication based on communication control data received from the selected control.

40. The method of claim 28 wherein interpreting the state data to perform the action comprises operating a speakerphone based on communication control data received from the selected control.

41. The method of claim 28 wherein interpreting the state data to perform the action comprises opening an email application program based on email control data received from the selected control.

42. The method of claim 28 wherein interpreting the state data to perform the action comprises accessing voice mail data based on voice mail control data received from the selected control.

43. The method of claim 28 wherein interpreting the state data to perform the action comprises changing a power state based on power control data received from the selected control.

44. The method of claim 28 wherein interpreting the state data to perform the action comprises changing a security state based on security control data received from the selected control.

45. The method of claim 28 wherein interpreting the state data to perform the action comprises adjusting a volume based on volume control data received from the selected control.

46. The method of claim 28 wherein interpreting the state data to perform the action comprises operating a transport based on transport control data received from the selected control.

47. The method of claim 28 wherein interpreting the state data to perform the action comprises recording audio and/or visual data based on record control data received from the selected control.

48. The method of claim 28 wherein interpreting the state data to perform the action comprises providing system information.

49. A computer-readable medium having computer-executable instructions for performing the method of claim 28.

50. In a computer system, a subsystem comprising:
means for receiving state data corresponding to a selected control of a plurality of controls arranged on a control panel;
means for interpreting the state data; and
means for performing an action according to the interpretation of the state data with respect to a current context of a computing task.

51. The subsystem of claim 50 further comprising means for controlling an indicator to convey information about the state of the computing task to which the selected control is associated.

52. The subsystem of claim 50 wherein the action performed according to the interpretation of the state data with respect to a current context of a computing task comprises launching an application program.

53. The subsystem of claim 50 wherein the action performed according to the interpretation of the state data with respect to a current context of a computing task comprises launching an application program.

54. The subsystem of claim 50 wherein the action performed according to the interpretation of the state data with respect to a current context of a computing task comprises handling a communication.

55. The subsystem of claim 50 wherein the action performed according to the interpretation of the state data with respect to a current context of a computing task comprises operating an input mechanism.

56. The subsystem of claim 50 wherein the action performed according to the interpretation of the state data with respect to a current context of a computing task comprises operating an output mechanism.

57. The subsystem of claim 50 wherein the action performed according to the interpretation of the state data with respect to a current context of a computing task comprises providing system information.
